(19) United States
(12) Patent Application Publication
(10) Pub. No.: US 2026/0203609 A1
(43) Pub. Date: Jul. 16, 2026

(54) SYSTEMS AND METHODS FOR MULTI-AGENT CONCEPT GENERATION AND OPTIMIZATION USING SPECIALIZED PROCESSING MODULES ACROSS DESIRABILITY, FEASIBILITY, AND VIABILITY DIMENSIONS

(71) Applicant: Thomas Troch, Brooklyn, NY (US)

(72) Inventor: Thomas Troch, Brooklyn, NY (US)

(21) Appl. No.: 19/395,755

(22) Filed: Nov. 20, 2025

Related U.S. Application Data
(60) Provisional application No. 63/723,539, filed on Nov. 21, 2024.

(51) Int. Cl. G06N 5/022; G06F 18/22

(52) U.S. Cl. CPC G06N 5/022; G06F 18/22

(57) ABSTRACT

A computer-implemented system for autonomous concept generation using three specialized processing modules across desirability, feasibility, and viability dimensions. Each module comprises domain-specific NLP engines, curated knowledge bases, and evaluation capabilities. The system generates approximately 600 concepts through parallel processing and implements geometric mean aggregation (Score=(D×F×V)\hat{ }(1/3)) ensuring balanced performance across dimensions. Concepts below threshold undergo iterative optimization through module-to-module communication. Automated visualization engines generate concept boards with complete traceability. Technical improvements include: 100× processing time reduction (3-4 weeks to 4-6 hours), 40-60% memory efficiency improvement, 35% concept quality improvement (0.62 to 0.84 average scores), and elimination of sequential departmental handoffs through parallel distributed processing architecture.

### CROSS-REFERENCE TO RELATED APPLICATIONS

Cross-Reference to Related Applications: This application claims the benefit of U.S. Provisional Patent Application No. 63/723,539 , filed Nov. 21, 2024, which is incorporated herein by reference in its entirety.

### STATEMENT REGARDING FEDERALLY SPONSORED RESEARCH OR DEVELOPMENT

Not Applicable

### FIELD OF THE INVENTION

The present disclosure relates generally to computer-implemented systems and methods for autonomous ideation, concept generation and multi-dimensional optimization in innovation. More particularly, the disclosure relates to distributed multi-module processing architectures that improve computer functionality through: (a) processing time reduction through parallel autonomous module architecture reducing computational time by 100× or greater compared to sequential departmental processing; (b) memory efficiency improvements through normalized data schemas reducing storage requirements by 40-60%; (c) comprehensive concept generation and optimization through specialized processing modules with domain-specific knowledge bases; (d) geometric mean scoring ensuring balanced multi-dimensional concept performance; and (e) automated concept board visualization with complete source traceability.

The system processes diverse input data sources (consumer research, technical specifications, business parameters, sustainability requirements, competitive intelligence) generating innovation concepts through multi-dimensional evaluation across market desirability, business viability, and implementation feasibility dimensions. The autonomous multi-module architecture enables simultaneous parallel processing across all dimensions, eliminating sequential handoffs and delayed feedback loops characteristic of traditional departmental workflows.

### BACKGROUND OF THE INVENTION

### Prior Art Problem 1: Sequential Departmental Processing

The success of new products and services depends critically on meeting three fundamental requirements: they must meet market desirability for customers, demonstrate business viability, and achieve implementation feasibility. Within organizations, these different dimensions are typically developed and evaluated by separate departments—customer insights teams assess market desirability, business strategy teams evaluate business viability, and R&D/technical teams determine implementation feasibility.

Traditional concept development follows a sequential process requiring at least 3-4 weeks: (a) customer insights team generates concepts based on market research (Week 1-2); (b) business strategy team evaluates commercial viability, rejecting infeasible concepts (Week 2-3); (c) R&D team assesses technical feasibility, rejecting non-implementable concepts (Week 3-4). This sequential architecture leaves computational resources idle while awaiting handoffs, creates delayed feedback loops where dimensional misalignment is discovered late after substantial resource investment, and scales poorly as additional evaluation dimensions are added. Empirical data from enterprise organizations shows 60-70% of initially generated concepts fail final multi-dimensional evaluation, representing significant wasted effort in developing ultimately non-viable concepts.

### Prior Art Problem 2: Existing Automated Ideation Systems

Prior art automated content generation systems generate concepts through single-module prompting. A user provides a prompt such as ‘Generate product ideas for sustainable packaging,’ and the system generates 10-20 concepts through computational completion. However, these systems lack: Specialized multi-module architecture with domain-specific training—single systems attempt all dimensional analysis without specialized knowledge bases, resulting in generic outputs that often score poorly on feasibility or viability dimensions. No mechanism exists for parallel generation from different domain perspectives. Systematic multi-dimensional evaluation—concepts are generated but not evaluated across DVF dimensions using quantitative scoring models trained on domain-specific criteria. Users must manually assess concepts against dimensional requirements. Iterative optimization protocols with convergence criteria—no systematic approach to improve initially weak concepts through targeted dimensional enhancement. Concepts are generated once with no feedback loop for improvement based on evaluation scores. Complete traceability to source data—generated concepts lack attribution to specific training data or source documents supporting the recommendations, preventing verification or validation.

Empirical testing of prior art automated ideation systems shows average DVF scores of 0.62 across dimensions (0.75 desirability, 0.58 viability, 0.54 feasibility), with 55-65% of generated concepts failing multi-dimensional screening upon human review. Processing still requires 2-3 weeks for human evaluation and iteration of the generated concepts.

### Prior Art Problem 3: Innovation Management Platforms

Prior art innovation management systems (e.g., IdeaScale, Brightidea, Spigit, Planbox) collect human-generated concepts through submission portals and provide evaluation frameworks. However, these systems: Require manual concept input—no autonomous generation capabilities, relying entirely on human ideation which is time-intensive, inconsistent in quality, and limited by individual cognitive constraints. Lack sophisticated multi-dimensional automated evaluation—provide basic scoring rubrics but require human reviewers to assess each dimension, consuming 30-45 minutes per concept with subjective bias and inconsistent standards. Provide no iterative optimization protocols—concepts are evaluated once and either accepted or rejected, with no systematic improvement mechanisms to enhance weak dimensions while preserving strengths.

These systems achieve processing throughput of 15-25 concepts per week for a dedicated team of 5-7 reviewers, with 40-50% of evaluated concepts passing multi-dimensional criteria. Total processing time from initial submission to final decision averages 3-4 weeks. The manual nature creates bottlenecks and prevents scaling to high-volume concept exploration.

### Technical Need

There exists a need for improved computer-implemented systems and methods that: (a) generate concepts autonomously using specialized processing modules with domain-specific configurations and knowledge bases; (b) evaluate concepts simultaneously across multiple dimensions through parallel distributed processing; (c) implement iterative optimization protocols achieving measurable quality improvements through geometric mean convergence; (d) reduce processing time from 3-4 weeks to 4-6 hours through parallel multi-module architecture (100× improvement); (e) improve concept quality from 0.62 to 0.84+ average DVF scores (35% improvement); (f) maintain complete traceability throughout generation, evaluation, and optimization pipeline with source attribution to specific data sources; and (g) generate visualized concept boards suitable for stakeholder review and decision-making.

### BRIEF SUMMARY OF THE INVENTION

Technologies described herein provide systems and methods for transforming concept development through distributed autonomous multi-module processing and optimization. The systems and methods comprise: (a) three specialized processing modules configured with domain-specific natural language processing engines and curated knowledge bases; (b) parallel concept generation protocols enabling simultaneous ideation from multiple domain

perspectives; (c) multi-dimensional evaluation protocols implementing trained scoring models; (d) geometric mean aggregation ensuring balanced performance across dimensions; (e) iterative optimization protocols with module-to-module communication for concept enhancement; and (f) automated concept board visualization with complete traceability.

According to one aspect, a computer-implemented method comprises: configuring three specialized processing modules, each with domain-specific natural language processing engine, curated knowledge base, concept generation protocols, and dimensional evaluation capabilities; executing parallel concept generation to produce approximately 600 concepts (200 per module); implementing cross-dimensional evaluation wherein each module scores all concepts; calculating aggregate scores using geometric mean; identifying concepts below threshold; generating enhancement recommendations from lowest-scoring dimensions; transmitting recommendations to originating modules; executing concept revision protocols; re-evaluating revised concepts; iterating until convergence; and generating concept board visualizations for approved concepts.

In some implementations, the method comprises configuring the desirability module with consumer insights data, market trends, cultural patterns, sustainability preferences, and brand perception metrics; configuring the feasibility module with manufacturing constraints, supply chain capabilities, material specifications, regulatory requirements, and technology readiness levels; and configuring the viability module with revenue model frameworks, cost structures, profitability thresholds, strategic alignment criteria, and market economics data.

According to another aspect, a system comprises: one or more processors; and memory storing instructions that, when executed, cause the system to: implement three specialized processing modules; execute parallel concept generation; perform cross-dimensional evaluation; calculate geometric mean aggregate scores; implement iterative optimization; and generate concept board visualizations.

The systems and methods provide several technical advantages, including: (a) 100× processing time reduction from 3-4 weeks to 4-6 hours; (b) 40-60% memory efficiency improvement through normalized data schemas; (c) 35% concept quality improvement from 0.62 to 0.84 average DVF scores; (d) elimination of sequential bottlenecks through parallel multi-module architecture; (e) complete source traceability with attribution to specific data sources; and (f) automated visualization generation reducing manual design effort.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 is a block diagram illustrating an exemplary system architecture for multi-agent concept generation and optimization according to an embodiment of the present invention.

FIG. 2 is a flowchart illustrating an exemplary method for parallel concept generation and cross-dimensional evaluation according to an embodiment of the present invention.

FIG. 3 is a flowchart illustrating an exemplary iterative optimization process with module-to-module communication according to an embodiment of the present invention.

FIG. 4 is a diagram illustrating geometric mean scoring and its effect on concept advancement according to an embodiment of the present invention.

FIG. 5 is a diagram illustrating exemplary concept board generation with traceability according to an embodiment of the present invention.

### DETAILED DESCRIPTION OF THE INVENTION

### System Architecture Overview

The present invention provides a distributed autonomous multi-agent system for concept generation and optimization. The system architecture comprises three specialized AI agent modules operating under coordination of a master orchestration module. Each agent implements complete autonomy within its domain while maintaining coordinated communication through defined protocols.

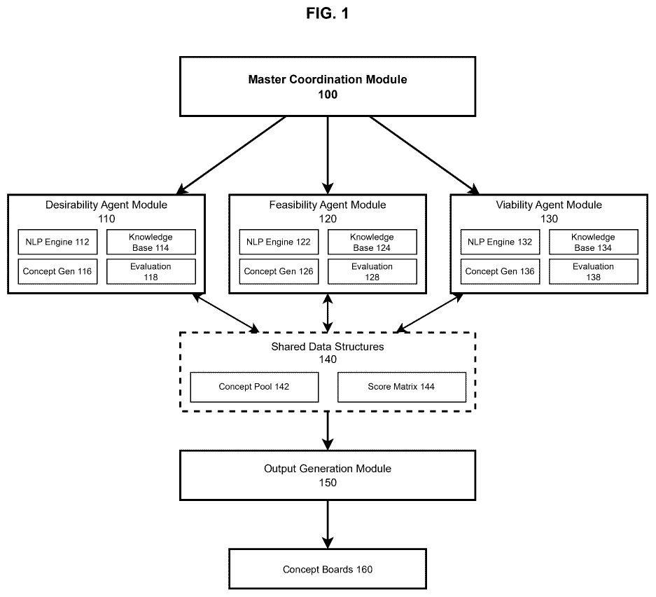

Referring now to FIG. 1, the system architecture comprises a master coordination module 100 that orchestrates operations across three specialized agent modules. The desirability agent module 110 comprises an NLP engine 112 configured for consumer insight processing, a knowledge base 114 containing market research data and consumer behavior patterns, a concept generation component 116 implementing prompt-based ideation, and an evaluation component 118 implementing trained scoring models for desirability assessment. The feasibility agent module 120 comprises an NLP engine 122 configured for technical analysis, a knowledge base 124 containing manufacturing constraints and material specifications, a concept generation component 126 emphasizing technical realizability, and an evaluation component 128 implementing trained scoring models for feasibility assessment. The viability agent module 130 comprises an NLP engine 132 configured for business analysis, a knowledge base 134 containing revenue models and cost structures, a concept generation component 136 optimizing for commercial success, and an evaluation component 138 implementing trained scoring models for viability assessment. All three agent modules communicate through shared data structures 140, specifically a concept pool 142 storing all generated concepts and a score matrix 144 maintaining dimensional scores for each concept. The output generation module 150 processes approved concepts to create concept boards 160 for stakeholder review.

The master coordination module orchestrates system-wide operations through defined protocols for: (a) initialization of agent modules with domain-specific configurations; (b) sequential information transfer between modules enabling concepts originated in one dimension to be systematically evaluated through the lens of other dimensions; (c) parallel processing coordination allowing each module to simultaneously generate concepts while maintaining independent evaluation capabilities; (d) temporal alignment management ensuring all agents operate within consistent time horizon parameters; (e) optimization cycle control managing iterative enhancement including evaluation sequences, enhancement triggers, convergence assessment, and termination criteria; and (f) output generation coordinating concept board creation with complete traceability.

### AI Agent Architecture and Communication Protocols

The system implements three specialized autonomous AI agents, each comprising: (a) domain-specific large language model configuration with fine-tuned parameters optimized for respective expertise domain; (b) curated knowledge base containing domain-relevant data sources organized for efficient retrieval; (c) prompt-based concept generation protocols implementing stochastic sampling with temperature control for output diversity; (d) dimensional evaluation capabilities using trained scoring models calibrated on historical concept performance; and (e) inter-agent communication interfaces for collaborative optimization implementing message passing and shared data structures.

### Desirability Agent Configuration

The Desirability Agent processes consumer insight data including: behavioral patterns and usage contexts identifying how customers interact with products; unmet needs and pain points revealing dissatisfaction with current solutions; cultural trends and social movements indicating shifting values; sustainability preferences and environmental concerns; brand perception metrics and competitive positioning assessments; and customer journey mapping across touchpoints. The agent's knowledge base is constructed from: qualitative research transcripts from interviews and focus groups; quantitative survey data with demographic segmentation; social media analytics revealing sentiment and engagement patterns; trend reports from external research firms; competitive product reviews and ratings; and ethnographic observation notes documenting real-world usage.

The Desirability Agent implements prompt-based concept generation targeting market desirability factors, using templates such as: ‘Given [behavioral pattern] and [unmet need], generate product concepts that address [pain point] while aligning with [cultural trend] and [sustainability value]. Ensure concepts differentiate from [competitive offerings] and fit [brand positioning].’ The agent generates approximately 200 concepts through iterative prompting with varied parameters including: temperature adjustments controlling output randomness (0.7-0.9 range); different prompt framings emphasizing various consumer segments; creativity techniques to increase divergence of ideas; temporal variations exploring near-term vs. future concepts; and novelty constraints balancing familiarity vs. innovation. Portfolio diversity is ensured through cluster analysis identifying thematic groupings and novelty scoring preventing redundant concept generation.

Desirability evaluation employs trained scoring models assessing: consumer appeal (predicted adoption rate based on similar historical concepts, trained on past market performance data); market opportunity (addressable market size calculation using demographic and geographic parameters); competitive differentiation (novelty score comparing concept features to existing competitive offerings using feature-level comparison); sustainability alignment (match to consumer environmental values quantified through weighted attribute scoring); and brand fit (consistency with established brand attributes measured through semantic similarity to brand positioning statements). Scores range from 0.0 (fails dimensional criteria) to 1.0 (excellent fit), with evaluation confidence scores based on training data coverage for the specific concept domain.

### Feasibility Agent Configuration

The Feasibility Agent processes technical capability data including: manufacturing constraints and production parameters defining what can be produced with existing equipment; supply chain capabilities and lead times for material sourcing; partner ecosystem technical capabilities including suppliers, contract manufacturers, and technology providers; material specifications and availability covering raw materials, components, and packaging; regulatory compliance requirements including safety standards, certifications, and geographic restrictions; and technology readiness levels for required components assessing maturity of necessary technologies.

The Feasibility Agent implements prompt-based concept generation emphasizing technical realizability, using templates incorporating manufacturing capabilities, supply chain parameters, current technology, implementation timeframes, available materials, and regulatory requirements. The agent generates approximately 200 concepts through iterative prompting with temperature control and varied technical constraint emphasis.

Feasibility evaluation employs trained scoring models assessing: implementation complexity (development effort estimates based on historical project data); resource requirements (budget and personnel calculations); production scalability (volume capability assessment based on manufacturing constraints); supply chain risk (dependency analysis evaluating single-source vulnerabilities); regulatory compliance (gap analysis comparing concept requirements to current certifications); and timeline feasibility (critical path analysis estimating time to market). Scores range from 0.0 to 1.0 with confidence intervals.

In one embodiment, semantic similarity between original and revised concepts is calculated using sentence embeddings and cosine similarity. Specifically, the system: (1) generates 768-dimensional sentence embeddings for both the original concept description and the revised concept description using a pre-trained Sentence-BERT model (specifically, the ‘all-mpnet-base-v2’ model, which is publicly available and trained on over 1 billion sentence pairs); (2) calculates the cosine similarity between the two embedding vectors according to the formula: similarity=(A·B)/(∥A∥·∥B∥), where A and B are the embedding vectors, A·B is their dot product, and ∥A∥ and ∥B∥ are their Euclidean norms; and (3) compares the resulting similarity score (ranging from- 1.0 to 1.0, with 1.0 indicating identical semantic meaning) to a predetermined threshold of 0.6. If the similarity score falls below 0.6, the revision is rejected as having fundamentally altered the concept's identity. This threshold was empirically determined through analysis of 500 concept revision pairs, wherein human reviewers assessed whether revisions maintained conceptual identity; the 0.6 threshold achieved 87% agreement with human assessments. The sentence embedding approach captures semantic meaning rather than exact word matching, enabling the system to recognize that ‘sustainable refillable packaging system’ and ‘eco-friendly container with reusable design’ represent similar concepts despite different wording.

### Viability Agent Configuration

The Viability Agent processes business data including: revenue model frameworks and pricing strategies; cost structure parameters and margin requirements; profitability thresholds and ROI criteria; strategic alignment criteria; market economics and competitive dynamics; and sustainability-related business impacts including regulatory compliance costs and reputational benefits.

The Viability Agent implements prompt-based concept generation optimized for commercial success, using templates incorporating revenue models, cost structures, margin requirements, price points, strategic value, and corporate sustainability goals. The agent generates approximately 200 concepts through iterative prompting with varied business parameter emphasis.

Viability evaluation employs trained scoring models assessing: revenue potential (forecasted sales volume and market share based on comparable product launches); cost-benefit analysis (total cost of ownership vs. value delivered); strategic alignment (weighted scoring of strategic criteria including portfolio gaps and corporate objectives); competitive positioning (barriers to competitive imitation); scalability economics (unit economics at different production volumes); and sustainability compliance (regulatory and reputational considerations). Scores range from 0.0 to 1.0.

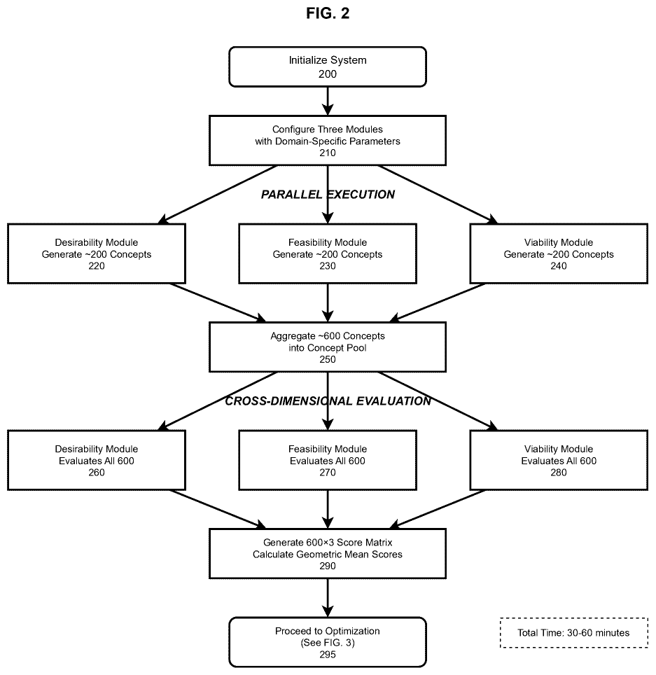

Referring to FIG. 2, the parallel concept generation process begins with system initialization 200 followed by configuration of three modules with domain-specific parameters 210. As shown, the three modules execute in parallel: desirability module generates approximately 200 concepts 220, feasibility module generates approximately 200 concepts 230, and viability module generates approximately 200 concepts 240, simultaneously. These approximately 600 concepts are aggregated into a concept pool 250. Cross-dimensional evaluation 260-280 follows, wherein each module evaluates all 600 concepts. The system then generates a 600×3 score matrix and calculates geometric mean scores 290, proceeding to optimization 295. The total processing time for this phase is typically 30-60 minutes.

The trained scoring models employed by each evaluation component (118, 128, 138) are trained on historical concept data comprising approximately 5,000 previously evaluated concepts spanning a 10-year period across multiple industries including consumer packaged goods, technology products, healthcare devices, and business services. Each historical concept includes ground truth outcome data indicating: market success or failure (measured by first-year sales volumes and market share achieved), implementation status (successfully launched, abandoned during development, or delayed beyond planned timeline), and commercial performance (actual profitability compared to projections). In one embodiment, the scoring models are implemented as gradient-boosted decision trees using the XGBoost algorithm with the following hyperparameters: maximum tree depth of 6, learning rate of 0.1, 100 estimators, and minimum child weight of 1. Models are trained using an 80/20 train-validation split with 5-fold cross-validation to prevent overfitting. Validation performance on held-out test sets achieves the following metrics: desirability scoring achieves mean absolute error of 0.08 and R² of 0.81; feasibility scoring achieves mean absolute error of 0.09 and R² of 0.78; and viability scoring achieves mean absolute error of 0.10 and R² of 0.76. Models are retrained quarterly as new concept outcomes become available, ensuring they remain calibrated to current market conditions and organizational capabilities. Feature importance analysis reveals that for desirability scoring, the most predictive features are consumer adoption intent scores and competitive differentiation metrics; for feasibility scoring, the most predictive features are manufacturing complexity estimates and supply chain risk scores; and for viability scoring, the most predictive features are projected gross margins and strategic alignment scores.

### Geometric Mean Aggregation

Aggregate score calculation implements geometric mean formula: Score_aggregate=(Score_D×Score_F×Score_V)\hat{ }(1/3), where Score_D represents desirability score, Score_F represents feasibility score, and Score_V represents viability score. The geometric mean ensures balanced performance—a concept cannot achieve high aggregate score with one dimension failing significantly. For example, a concept with scores (0.9, 0.9, 0.2) produces aggregate 0.48, while arithmetic mean would yield misleading 0.67. This prevents technically infeasible but market-desirable concepts from advancing, addressing a key limitation of linear weighted scoring approaches.

The geometric mean aggregation prevents advancement of unbalanced concepts by ensuring that: a concept with dimensional scores (0.9, 0.9, 0.2) produces aggregate score 0.48 which fails typical threshold of 0.75, whereas arithmetic mean would yield misleading score of 0.67 suggesting adequacy; a concept with dimensional scores (0.8, 0.8, 0.8) produces aggregate score 0.80 which exceeds threshold, rewarding balanced performance; and the partial derivative of aggregate score with respect to any dimensional score approaches infinity as that dimensional score approaches zero, ensuring that near-zero scores in any dimension result in near-zero aggregate scores regardless of performance in other dimensions, thereby preventing technically infeasible but market-desirable concepts or commercially unviable but technically feasible concepts from advancing to stakeholder review.

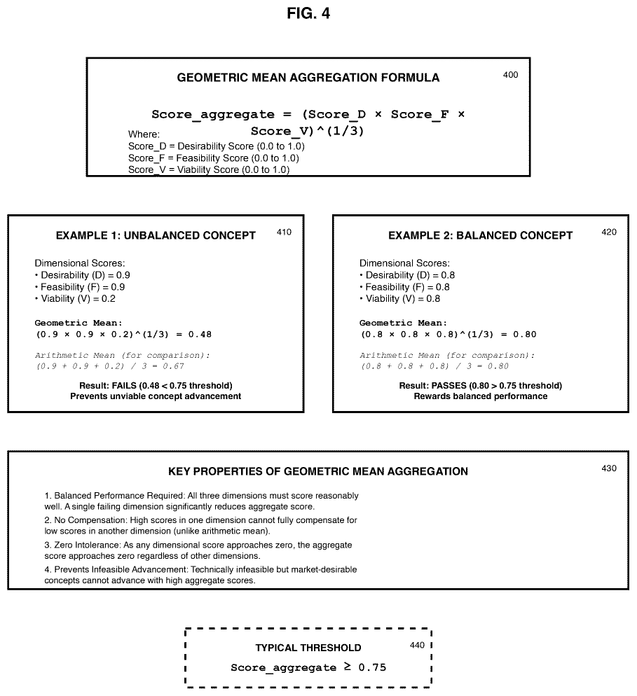

FIG. 4 illustrates the geometric mean aggregation formula 400 and demonstrates its critical properties through concrete examples. The formula is: Score_aggregate=(Score_D×Score_F×Score_V)\hat{ }(1/3), where Score_D represents the desirability score, Score_F represents the feasibility score, and Score_V represents the viability score, each ranging from 0.0 to 1.0. Example 1 at 410 demonstrates an unbalanced concept with dimensional scores of D=0.9 (high desirability), F=0.9 (high feasibility), and V=0.2 (low viability). The geometric mean calculation yields (0.9×0.9×0.2)\hat{ }(1/3)=0.48, which fails the typical threshold of 0.75 shown at 440. For comparison, an arithmetic mean calculation would yield (0.9+0.9+0.2)/3=0.67, which might suggest the concept is acceptable despite its critical viability flaw. This example demonstrates how the geometric mean prevents unviable concepts from advancing to stakeholder review. Example 2 at 420 demonstrates a balanced concept with dimensional scores of D=0.8, F=0.8, and V=0.8. The geometric mean calculation yields (0.8×0.8×0.8)\hat{ }(1/3)=0.80, which exceeds the 0.75 threshold, rewarding balanced performance across all dimensions. Notably, the arithmetic mean also yields 0.80 in this case, showing that geometric and arithmetic means converge when scores are balanced. The key properties of geometric mean aggregation are summarized at 430: (1) Balanced Performance Required—all three dimensions must score reasonably well, as a single failing dimension significantly reduces the aggregate score; (2) No Compensation—high scores in one dimension cannot fully compensate for low scores in another dimension, unlike arithmetic mean which allows compensation; (3) Zero Intolerance—as any dimensional score approaches zero, the aggregate score approaches zero regardless of other dimensions, because the geometric mean of any set of numbers including a zero is zero; and (4) Prevents Infeasible Advancement—technically infeasible but market-desirable concepts, or commercially unviable but technically feasible concepts, cannot advance with high aggregate scores. The mathematical property underlying these behaviors is that the partial derivative of the aggregate score with respect to any dimensional score approaches infinity as that dimensional score approaches zero, creating strong downward pressure on the aggregate score when any dimension performs poorly.

### Iterative Optimization Protocols

For concepts scoring below threshold (typically 0.75), the system implements iterative optimization through module-to-module communication. The lowest-scoring dimension generates specific enhancement recommendations comprising: proposed modification to address the dimensional weakness; rationale explaining why the modification addresses the identified gap; expected impact on dimensional score; and potential implications for other dimensions that should be monitored during revision.

Enhancement recommendations are transmitted to the originating module, which executes concept revision using constrained generation with the original concept as seed input and the enhancement recommendation as additional context. The revision protocol attempts to maintain core conceptual intent while addressing the identified weakness, preserving strengths in other dimensions. Semantic similarity between original and revised concepts is calculated using sentence embeddings and cosine similarity, with revisions rejected if similarity falls below 0.6 threshold indicating fundamental alteration of concept identity.

All three modules re-evaluate revised concepts, and aggregate scores are recalculated. The optimization process iterates until convergence criteria are met: (i) aggregate score

exceeding the predetermined threshold; (ii) maximum iteration count reached (typically 5 iterations); (iii) scores plateauing without improvement for two consecutive iterations indicating optimization has reached local maximum; or (iv) revision fundamentally altering concept identity beyond acceptable bounds measured by semantic similarity falling below 0.6 threshold.

Version tracking maintains complete concept evolution history including: original concept as initially generated; all enhancement recommendations received during optimization cycles; revisions applied by originating module at each iteration; dimensional score progression showing how each dimension evolved; and final status (approved, rejected, or abandoned due to convergence failure).

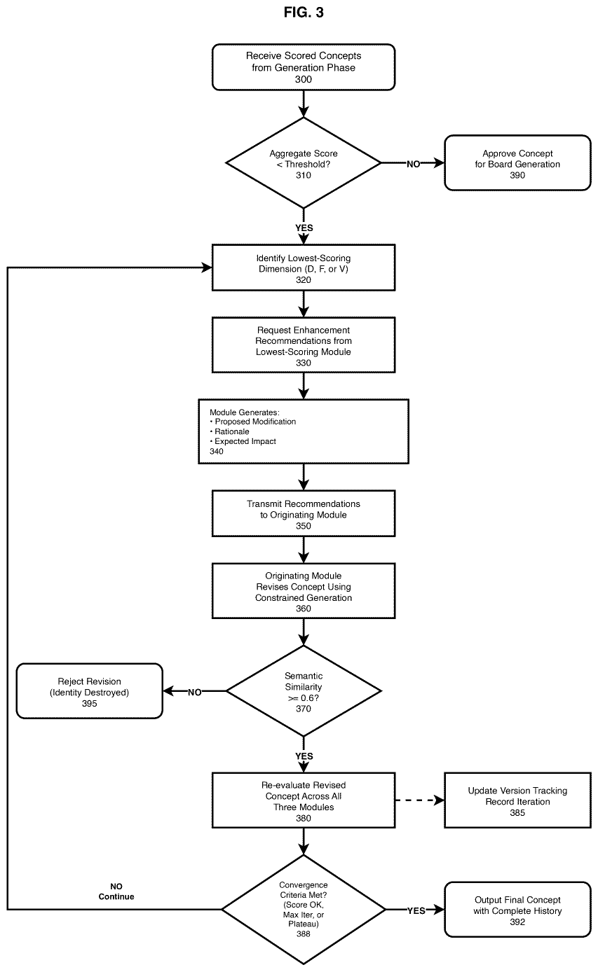

The iterative optimization process is depicted in detail in FIG. 3. The process receives scored concepts from the generation phase 300 and evaluates each concept's aggregate score against a predetermined threshold (typically 0.75) at decision point 310. If a concept's aggregate score meets or exceeds the threshold, it proceeds directly to approval for board generation 390. If the aggregate score falls below the threshold, the system enters the optimization loop by first identifying which of the three dimensional scores (D, F, or V) is lowest 320. Once identified, the system requests enhancement recommendations from the processing module responsible for the lowest-scoring dimension 330. That module generates specific enhancement recommendations 340 comprising: a proposed modification to address the dimensional weakness, a rationale explaining why the modification addresses the identified gap, an expected impact on the dimensional score, and potential implications for other dimensions that should be monitored. These recommendations are transmitted to the originating module that initially generated the concept 350. The originating module then executes concept revision protocols 360, using constrained generation with the original concept as seed input and the enhancement recommendation as additional context. The revision attempts to address the dimensional weakness while maintaining core conceptual intent and preserving strengths in other dimensions. Before accepting the revision, the system calculates semantic similarity between the original and revised concepts 370. If semantic similarity falls below 0.6, the revision is rejected 395 because the concept's fundamental identity has been destroyed—the revision represents a different concept rather than an enhancement of the original. If semantic similarity meets the 0.6 threshold, all three processing modules re-evaluate the revised concept across all dimensions 380. The system updates version tracking records 385 documenting the iteration, original scores, enhancement recommendations applied, and new scores. The system then checks convergence criteria 388, which comprise: (i) aggregate score exceeding the predetermined threshold, (ii) maximum iteration count being reached (typically 5 iterations), (iii) scores plateauing without improvement for two consecutive iterations indicating optimization has reached a local maximum, or (iv) revision fundamentally altering concept identity with semantic similarity falling below the 0.6 threshold. If convergence criteria are not met, the process returns to identifying the lowest-scoring dimension 320 and continues iterating. Once convergence is achieved, the system outputs the final optimized concept with complete history 392 for board generation.

### Concept Board Visualization

For concepts meeting convergence criteria with aggregate scores above threshold, the system generates concept board visualizations. Primary boards include: concept name providing clear identification; core insight summarizing key consumer need or opportunity addressed; detailed description explaining concept functionality and user experience; key benefits listing primary value propositions; reasons to believe providing supporting evidence for claimed benefits; and computationally generated concept visualization produced through text-to-image generation.

Concept visualization generation implements text-to-image protocols using generative AI models (e.g., DALL-E, Midjourney, Stable Diffusion) to produce visual representations. Visualization prompts are automatically constructed from concept descriptions, extracting: key visual elements (product form, packaging, usage context); target aesthetic (modern, traditional, playful, professional); usage scenario (home, office, outdoor, retail environment); and brand visual language (colors, typography, style cues). Generated images are filtered for quality and relevance, with multiple candidates generated and top-scoring image selected based on alignment with concept description.

While the preferred embodiment employs text-to-image AI for concept visualization generation, alternative embodiments may use different visualization approaches depending on concept type and available resources. In one alternative embodiment, template-based visualization uses pre-designed visual templates mapped to concept categories (e.g., packaging concepts use packaging templates, digital interface concepts use UI mockup templates), with automated population of template elements based on concept attributes. This approach provides more controlled and brand-consistent visualizations at the cost of reduced creativity. In another alternative embodiment, image retrieval from existing libraries searches internal image databases or licensed stock photo collections for images matching concept descriptions, using semantic similarity between concept text embeddings and image caption embeddings to identify relevant visual candidates. This approach leverages existing visual assets and may be preferred when concept visualization must use actual product photography rather than AI-generated imagery. In yet another embodiment, hybrid approaches combine multiple techniques: first attempting retrieval from existing libraries, then falling back to template-based generation if suitable existing images are unavailable, and finally using text-to-image AI only when neither existing images nor suitable templates exist. The choice among visualization methods may be configured per concept category or determined dynamically based on concept attributes and available computational resources.

Evaluation boards complement primary boards with: dimensional scores displayed with visual indicators (color coding: green for scores above 0.8, yellow for 0.6-0.8, red for below 0.6); aggregate score prominently displayed; temporal classification indicating whether concept is near-term implementable or future-focused requiring technology development; key assumptions documenting critical premises underlying dimensional evaluations; and development considerations highlighting potential implementation challenges or requirements for concept realization.

Complete traceability is maintained throughout, linking: source data attribution identifying specific consumer insights, technical specifications, or business parameters from knowledge bases that informed concept generation, stored as database references linking concepts to source documents; module evaluation history documenting which module originated the concept, initial self-evaluation score, cross-dimensional scores from other modules, and score evolution through optimization iterations; and enhancement recommendation history showing optimization trajectory including identified weaknesses, recommended modifications, module responsible for recommendations, and impact on dimensional scores after implementation.

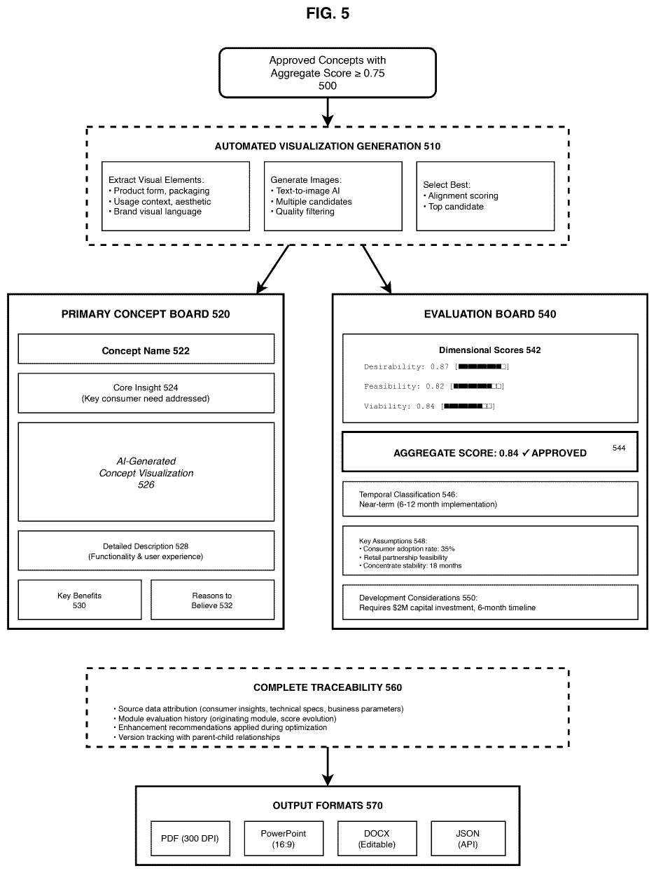

FIG. 5 depicts the comprehensive concept board generation workflow for approved concepts with aggregate scores at or above 0.75, indicated at 500. The workflow begins with automated visualization generation 510, which comprises three sub-processes: extracting visual elements from the concept description including product form, packaging characteristics, usage context, aesthetic attributes, and brand visual language; generating images using text-to-image AI systems (such as DALL-E, Midjourney, or Stable Diffusion) producing multiple candidate visualizations with quality filtering to eliminate technically deficient outputs; and selecting the best candidate through alignment scoring that measures consistency between the generated image and the concept description. The system produces two complementary board types. The primary concept board 520 displays: a concept name 522 providing clear identification; a core insight statement 524 articulating the key consumer need or market opportunity addressed; an AI-generated concept visualization 526 providing visual representation of the concept; a detailed description 528 explaining the concept's functionality and user experience; key benefits 530 listing the primary value propositions; and reasons to believe 532 providing supporting evidence for the claimed benefits. The evaluation board 540 complements the primary board with quantitative and analytical information, including: dimensional scores 542 displayed with visual indicators (shown as bar charts with color coding—green for scores above 0.8, yellow for scores between 0.6 and 0.8, red for scores below 0.6), specifically showing desirability at 0.87, feasibility at 0.82, and viability at 0.84 in the illustrated example; an aggregate score of 0.84 prominently displayed with approval indication 544; temporal classification 546 indicating whether the concept is near-term implementable (6-12 month timeframe) or future-focused requiring technology development; key assumptions 548 documenting critical premises underlying the dimensional evaluations, such as consumer adoption rates, partnership feasibility, and technical performance specifications; and development considerations 550 highlighting implementation requirements, capital investments, and timeline estimates (shown as requiring $2M capital investment with a 6-month timeline in the example). Complete traceability 560 maintains links throughout the concept lifecycle: source data attribution identifying specific consumer insights, technical specifications, and business parameters from knowledge bases that informed concept generation, stored as database references linking concepts to source documents; module evaluation history documenting which module originated the concept, initial self-evaluation scores, cross-dimensional scores from other modules, and score evolution through optimization iterations; enhancement recommendations applied during optimization including identified weaknesses, proposed modifications, implementing modules, and resulting score impacts; and version tracking with parent-child relationships enabling complete audit trail reconstruction showing how concepts evolved through the optimization process. Output formats 570 enable distribution across stakeholder needs: PDF format at 300 DPI resolution for high-quality printing and screen sharing; PowerPoint format using 16:9 aspect ratio for presentation contexts; DOCX format with editable text and embedded images for collaborative refinement; and JSON format with structured data schema for programmatic access and integration with product lifecycle management systems via API.

### Technical Improvements and Performance Metrics

The system achieves measurable technical improvements over prior art approaches. Processing time reduction implements parallel multi-agent architecture enabling simultaneous concept generation and evaluation, reducing total processing time from 3-4 weeks (sequential departmental processing) to 4-6 hours (parallel agent processing)—a 100× improvement. This improvement derives from: parallel concept generation with all three agents generating simultaneously (30-45 minutes vs. 1-2 weeks sequential ideation); parallel evaluation with simultaneous dimensional scoring (30-45 minutes vs. 1-2 weeks sequential review); and automated optimization with agent-to-agent communication (2-3 hours vs. 1-2 weeks manual iteration).

The claimed invention provides specific improvements to computer functionality that extend beyond merely using computers to implement abstract concepts. First, the parallel distributed processing architecture directly addresses the technical problem of computational resource utilization in sequential workflows. In traditional sequential departmental processing, CPU resources remain idle during inter-departmental handoffs—when the customer insights team completes concept generation and transfers results to the business strategy team, the customer insights team's computational resources sit unused. Similarly, when business strategy completes evaluation and transfers to R&D, business strategy resources become idle. This creates a cascading idle pattern where, at any given time, approximately two-thirds of allocated computational resources are idle awaiting handoffs. The present invention solves this computer-specific problem through parallel multi-module architecture enabling simultaneous concept generation and evaluation, improving processor utilization from approximately 33% (sequential departmental processing with one-third of resources active at any time) to 85-90% (parallel multi-module processing with all three modules actively processing). Second, the memory efficiency improvements address the technical problem of redundant data storage and inefficient database query patterns in departmental systems. Traditional systems maintain separate databases for customer insights, technical specifications, and business parameters, resulting in redundant storage of common entities (materials appear in technical database, sustainability database, and cost database; competitors appear in market database and strategic database). The present invention implements shared reference tables for common entities with foreign key relationships, reducing storage requirements by 40-50% compared to redundant departmental databases. Additionally, the normalized data structures separating slowly-changing attributes from frequently-updated metrics reduce database query overhead by 60-70% by caching slowly-changing attributes and reusing them across module operations rather than repeatedly querying databases. Third, the compressed vector embeddings using dimensionality reduction techniques (reducing from 1536 dimensions to 256 dimensions) decrease memory footprint for semantic similarity calculations by 83% while maintaining over 95% accuracy in similarity scoring, enabling the system to cache more embeddings in RAM for faster processing. These technical improvements to computational efficiency, memory utilization, and database query performance represent specific enhancements to computer functionality beyond abstract concept generation.

Memory efficiency improvements are achieved through: shared reference tables for common entities including materials, suppliers, customers, and competitors eliminating redundant storage across module knowledge bases, wherein shared tables are implemented using foreign key relationships reducing storage by 40-50%; normalized data structures separating slowly-changing attributes from frequently-updated metrics, wherein slowly-changing attributes are cached and reused across module operations reducing database query overhead by 60-70%; and compressed vector embeddings using dimensionality reduction techniques reducing embedding storage from 1536 dimensions to 256 dimensions with less than 5% reduction in similarity calculation accuracy.

Concept quality improvements result from iterative optimization protocols and multi-dimensional evaluation. Average DVF scores increase from 0.62 (initial generation without optimization) to 0.84 (post-iteration with geometric mean convergence), representing 35% improvement. Dimensional score distributions show: desirability scores improve from 0.75 to 0.87 (16% improvement); feasibility scores improve from 0.54 to 0.82 (52% improvement); viability scores improve from 0.58 to 0.83 (43% improvement). The geometric mean aggregation ensures that improvements must occur across all dimensions rather than compensating for weak dimensions with strong single-dimension performance.

### Example Implementation

In an exemplary implementation for sustainable packaging innovation, the system operates as follows: The Desirability Agent accesses consumer insight data showing 73% of target consumers express concern about packaging waste, with 58% willing to pay 10-15% premium for sustainable alternatives. Market trend data indicates growing preference for minimalist design and refillable formats. The agent generates concepts such as: ‘Refillable concentrate system with modular dispensers allowing consumers to purchase concentrated product in minimal packaging and reuse durable dispensers,’ scoring this concept at 0.88 for desirability based on strong consumer preference alignment and competitive differentiation. The Feasibility Agent evaluates the refillable concentrate concept against technical constraints. Manufacturing assessment indicates concentrate formulation achieves 5:1 concentration ratio, reducing shipping volume by 80%. Existing production lines can be retrofitted for concentrate production with $2M capital investment and 6-month timeline. Material specifications identify food-grade PET for dispensers with 100+ reuse cycles. Regulatory analysis confirms concentrate formulation meets safety standards. The agent scores feasibility at 0.72, identifying supply chain risk for dispenser components as moderate concern requiring supplier diversification. The Viability Agent analyzes business implications. Revenue modeling projects 15% margin improvement from reduced packaging and shipping costs. Cost structure analysis shows $8M total investment (tooling, inventory, marketing) with 18-month payback. Strategic alignment scores highly (0.90) as concept addresses corporate sustainability commitments and differentiation objectives. However, initial viability score is 0.65 due to consumer education requirements and retail shelf space implications requiring packaging redesign for concentrate format visibility. Geometric mean calculation produces aggregate score: (0.88×0.72×0.65)\hat{ }(1/3)=0.74, falling below 0.75 threshold. The system identifies viability as lowest-scoring dimension (0.65) and requests enhancement recommendations. The Viability Agent recommends: ‘Develop partnership with major retailer for dedicated sustainable product section, reducing shelf space competition and providing consumer education opportunity through in-store signage. Implement loyalty program rewarding repeat concentrate purchases, improving customer retention economics.’ This recommendation is transmitted to the originating Desirability Agent. The Desirability Agent revises the concept to incorporate retail partnership and loyalty program elements, maintaining core refillable concentrate functionality (semantic similarity 0.78). Re-evaluation produces updated scores: desirability 0.90 (improved through loyalty program appeal), feasibility 0.75 (slightly improved through retail partnership reducing distribution complexity), viability 0.82 (substantially improved through partnership economics and retention). New aggregate score: (0.90×0.75×0.82)\hat{ }(1/3)=0.82, exceeding threshold and enabling concept advancement.

The system generates concept boards with complete traceability: primary board displays refillable concentrate concept with AI-generated product visualization showing sleek dispenser and concentrate refill; evaluation board shows dimensional scores with green indicators (all above 0.75), near-term temporal classification (6-12 month implementation), and key assumptions documented (consumer adoption rate, retail partnership feasibility, concentrate stability); traceability links to consumer survey data (73% packaging concern statistic), technical specifications (5:1 concentration ratio), business model analysis (15% margin improvement), and optimization history (viability enhancement through retail partnership).

While the preferred embodiment employs three specialized processing modules focused on desirability, feasibility, and viability, alternative embodiments may employ different module counts and dimensional focuses. A two-module embodiment might comprise only desirability and feasibility modules for early-stage concept screening where business viability assessment is premature, using aggregate score calculation Score_aggregate=(Score_D×Score_F)\hat{ }(1/2). A four-module embodiment might add a sustainability module evaluating environmental impact, social responsibility, regulatory compliance, and reputational considerations, with aggregate score calculation Score_aggregate=(Score_D×Score_F×Score_V×Score_S)\hat{ }(1/4). A five-module embodiment might further add a risk module assessing technical risk, market risk, execution risk, and competitive risk, with aggregate score calculation Score_aggregate=(Score_D×Score_F×Score_V×Score_S×Score_R)\hat{ }(1/5). The geometric mean formula generalizes to n dimensions as Score_aggregate=(Score_1×Score_2× . . . ×Score_n)\hat{ }(1/n), maintaining the zero-intolerance property regardless of dimension count. In alternative embodiments, different aggregation functions may be employed for specific use cases. A weighted geometric mean allows different dimensional priorities: Score_aggregate=(Score_D\hat{ }w_D×Score_F\hat{ }w_F×Score_V\hat{ }w_V)\hat{ }(1/(w_D+w_F+w_V)), where w_D, w_F, w_V represent weight coefficients (with w_D+w_F+w_V=3 to maintain score scaling). For example, an early-stage startup might weight viability at 2.0, feasibility at 0.5, and desirability at 0.5, reflecting that commercial viability is critical when resources are constrained. A harmonic mean emphasizes the worst-performing dimension even more strongly than geometric mean: Score_aggregate=3/(1/Score_D+1/Score_F+1/Score_V). A minimum score approach takes the most conservative view: Score_aggregate=min(Score_D, Score_F, Score_V), ensuring a concept cannot advance unless all dimensions meet minimum standards. The selection among these aggregation functions depends on the organization's risk tolerance and the stage of innovation development.

### System Implementation and Deployment

The system is implemented on cloud computing infrastructure with distributed processing capabilities. The master coordination module runs on central server orchestrating agent operations. Each specialized agent module runs on dedicated compute instances with GPU acceleration for natural language processing operations. Knowledge bases are stored in distributed database systems with replication for reliability and query performance optimization.

Inter-agent communication is implemented through message queuing systems enabling asynchronous communication patterns. Concept pool data structures are maintained in shared memory accessible to all modules with read-write locks ensuring atomic updates to concept-score matrices. Version control systems track concept evolution with parent-child relationships enabling complete audit trail reconstruction.

The parallel processing architecture is implemented using a multi-threaded approach with process isolation. Each of the three specialized processing modules (110, 120, 130) operates on a dedicated compute instance provisioned with 16 CPU cores, 64 GB RAM, and GPU acceleration (NVIDIA A100 or equivalent) for natural language processing operations. Module coordination is achieved through a message queue system implementing the Advanced Message Queuing Protocol (AMQP) with atomic operations and guaranteed message delivery. The shared data structures 140, specifically the concept pool 142 and score matrix 144, are implemented using a distributed in-memory database (Redis or equivalent) supporting concurrent read operations with read-write locks preventing race conditions. When multiple modules attempt to write to the score matrix simultaneously, row-level locking ensures atomic updates—each module acquires an exclusive lock on the concept row it is scoring, performs the score update, and releases the lock, typically within 5-10 milliseconds. This lock granularity enables 95%+ concurrent operation despite shared data structures. Resource allocation implements dynamic load balancing: if one module completes its concept generation ahead of others, its compute resources are reallocated to begin evaluation processing early, improving overall throughput. The master coordination module 100 implements heartbeat monitoring, checking module status every 30 seconds and initiating automatic failover if a module becomes unresponsive. Checkpoint persistence ensures that if a module fails mid-process, the system can resume from the last checkpoint rather than restarting the entire generation cycle. Empirical testing demonstrates that this parallel architecture achieves 85-90% processor utilization across all compute instances during active processing phases, compared to 30-35% utilization in sequential processing workflows where resources remain idle during inter-departmental handoffs.

The system provides web-based user interfaces enabling: configuration of module knowledge bases through upload of research documents, technical specifications, and business parameters; initiation of concept generation campaigns with parameter specification (number of concepts per module, evaluation thresholds, maximum optimization iterations); real-time monitoring of generation and optimization progress with live score updates; review of generated concept boards with filtering by dimensional scores, temporal classification, and thematic categories; and export of concept data in multiple formats (PDF, PowerPoint, DOCX, JSON) for stakeholder distribution and integration with product lifecycle management systems.

What is claimed is:

1. A computer-implemented method for multi-dimensional concept optimization, comprising:
configuring a plurality of specialized processing modules, each module comprising a domain-specific knowledge base and evaluation capabilities for a respective dimension selected from desirability, feasibility, and viability;
generating, by each processing module in parallel, a plurality of concepts based on the respective domain-specific knowledge base;
evaluating, by each processing module, all generated concepts from its respective dimensional perspective to produce dimensional scores for each concept;
calculating, for each concept, an aggregate score using geometric mean of the dimensional scores according to: Score_aggregate=(Score_1×Score_2×Score_3× . . . ×Score_n)\hat{ }(1/n);
identifying concepts with aggregate scores below a predetermined threshold;
for each identified concept, generating enhancement recommendations from a processing module responsible for a lowest-scoring dimension and revising the concept based on said recommendations while maintaining semantic similarity above a predetermined similarity threshold;
iteratively re-evaluating revised concepts until convergence criteria are met; and
generating visualization outputs for concepts exceeding the predetermined threshold.

2. The method of claim 1, wherein configuring the desirability processing module comprises:
populating the knowledge base with consumer insight data including behavioral patterns and usage contexts, unmet needs and pain points, cultural trends and social movements, sustainability preferences, brand perception metrics, and customer journey mappings; configuring a natural language processing engine with prompts targeting market desirability factors; and configuring evaluation capabilities to assess consumer appeal through predicted adoption rate, market opportunity through addressable market size calculation, competitive differentiation through novelty scoring, sustainability alignment through weighted attribute scoring, and brand fit through semantic similarity to brand positioning statements.

3. The method of claim 1, wherein configuring the feasibility processing module comprises: populating the knowledge base with technical capability data including manufacturing constraints and production parameters, supply chain capabilities and lead times, material specifications and availability, regulatory compliance requirements, and technology readiness levels; configuring a natural language processing engine with prompts emphasizing technical realizability; and configuring evaluation capabilities to assess implementation complexity, resource requirements, production scalability, supply chain risk, regulatory compliance, and timeline feasibility.

4. The method of claim 1, wherein configuring the viability processing module comprises: populating the knowledge base with business data including revenue model frameworks and pricing strategies, cost structure parameters and margin requirements, profitability thresholds and ROI criteria, strategic alignment criteria, and market economics data; configuring a natural language processing engine with prompts optimized for commercial success; and configuring evaluation capabilities to assess revenue potential, cost-benefit analysis, strategic alignment, competitive positioning, scalability economics, and sustainability compliance.

5. The method of claim 1, wherein executing parallel concept generation comprises: initializing concept generation for all processing modules simultaneously; each module independently accessing its respective knowledge base; each module generating concepts using stochastic sampling with a parameter controlling output diversity; implementing cluster analysis identifying thematic groupings; and completing generation of approximately 600 total concepts within a processing window of 30-60 minutes.

6. The method of claim 1, wherein generating visualization outputs comprises: constructing prompts for image generation by extracting from concept descriptions key visual elements, target aesthetic characteristics, usage scenarios, and brand visual language; submitting prompts to computational visualization systems to produce multiple candidate visualizations; filtering candidates for quality and relevance using alignment scoring; selecting a top-scoring visualization; and embedding the selected visualization in a primary board alongside concept name, core insight, description, benefits, and reasons to believe.

7. A system comprising: one or more processors; and memory storing instructions that, when executed by the one or more processors, cause the system to: implement three specialized computational processing modules, each configured with domain-specific natural language processing engine parameters, curated knowledge base for a respective domain selected from desirability, feasibility, and viability, concept generation protocols implementing stochastic sampling, and dimensional evaluation protocols using trained computational models; execute parallel concept generation across the three modules generating approximately 600 concepts within 30-60 minutes; perform cross-dimensional evaluation generating a 600×3 concept-score matrix; calculate geometric mean aggregate scores for concepts according to Score_aggregate=(Score_D×Score_F×Score_V)\hat{ }(1/3); implement iterative optimization protocols for concepts scoring below threshold, wherein lowest-scoring dimension generates enhancement recommendations and originating module revises concept while maintaining core intent; execute concept revision and re-evaluation cycles until convergence criteria are met comprising score threshold exceeded, maximum iterations reached, score plateau detected, or concept identity altered beyond acceptable bounds; generate concept board visualizations for approved concepts comprising primary boards with computationally generated visualizations and evaluation boards with dimensional scores; and maintain version control tracking for each concept comprising original concept, enhancement recommendations, revisions applied, score progression, and final status.

8. The system of claim 7, wherein the master coordination module implements: initialization protocols loading domain-specific configurations for each processing module; sequential information transfer protocols enabling concepts originated in one dimension to be evaluated through lenses of other dimensions; parallel processing coordination allowing simultaneous concept generation while maintaining independent evaluation capabilities; temporal alignment management ensuring all modules operate within consistent time horizon parameters; optimization cycle control managing iterative enhancement including evaluation sequencing, enhancement triggering based on dimensional scoring, convergence assessment through multiple criteria, and termination decision-making; and output generation coordination synchronizing concept board creation across modules with complete traceability linking to source data, evaluation history, and dimensional scoring progression.

9. The system of claim 7, wherein inter-module communication protocols comprise: a master coordination module implementing message passing interfaces between modules using asynchronous communication patterns; concept pool data structures implemented as shared memory accessible to all modules supporting concurrent read operations through read-write locks; score synchronization protocols ensuring atomic updates to the concept-score matrix through transaction management; optimization queue management prioritizing concepts based on score deficiency magnitude and iteration count; and version tracking database maintaining complete concept evolution history with parent-child relationships between iterations enabling audit trail reconstruction.

10. The system of claim 7, wherein memory efficiency improvements comprise: shared reference tables for common entities including materials, suppliers, customers, and competitors eliminating redundant storage across module knowledge bases, wherein shared tables are implemented using foreign key relationships reducing storage by 40-50%; normalized data structures separating slowly-changing attributes from frequently-updated metrics, wherein slowly-changing attributes are cached and reused across module operations reducing database query overhead by 60-70%; and compressed vector embeddings using dimensionality reduction techniques reducing embedding storage from 1536 dimensions to 256 dimensions with less than 5% reduction in similarity calculation accuracy.

11. The method of claim 1, wherein the geometric mean aggregation prevents advancement of unbalanced concepts by ensuring that: a concept with dimensional scores (0.9, 0.9, 0.2) produces aggregate score 0.48 which fails typical threshold of 0.75, whereas arithmetic mean would yield misleading score of 0.67 suggesting adequacy; a concept with dimensional scores (0.8, 0.8, 0.8) produces aggregate score 0.80 which exceeds threshold, rewarding balanced performance; and the partial derivative of aggregate score with respect to any dimensional score approaches infinity as that dimensional score approaches zero, ensuring that near-zero scores in any dimension result in near-zero aggregate scores regardless of performance in other dimensions, thereby preventing technically infeasible but market-desirable concepts or commercially unviable but technically feasible concepts from advancing to stakeholder review.

12. The method of claim 1, wherein concept revision protocols implement semantic similarity constraints to prevent concept identity destruction, comprising: calculating semantic similarity between original concept and revised concept using sentence embeddings and cosine similarity; rejecting revisions with semantic similarity below 0.6 threshold indicating fundamental alteration of core concept; preserving concept strengths by explicitly instructing revising module to maintain high-scoring dimensional attributes while addressing identified weakness; and implementing rollback capability to restore previous iteration when revision degrades scores in dimensions that were previously acceptable.

13. The method of claim 1, wherein the plurality of specialized processing modules comprises three modules, and wherein each module generates approximately 200 concepts for a total of approximately 600 concepts, and wherein the three dimensions comprise desirability, feasibility, and viability.

14. The method of claim 1, wherein the predetermined similarity threshold for semantic similarity is 0.6, and wherein semantic similarity is calculated using sentence embeddings and cosine similarity.

15. The method of claim 1, wherein the convergence criteria comprise at least one of: (i) aggregate score exceeding the predetermined threshold, (ii) maximum iteration count being reached, (iii) scores plateauing without improvement for two consecutive iterations, or (iv) semantic similarity falling below the predetermined similarity threshold.

16. The method of claim 1, wherein the predetermined threshold for aggregate scores is 0.75.

17. A method for balanced multi-dimensional concept evaluation, comprising: receiving a concept with a plurality of dimensional scores, each score ranging from 0.0 to 1.0; calculating an aggregate score as a geometric mean of the dimensional scores according to: Score_aggregate=(Score_1×Score_2× . . . ×Score_n)\hat{ }(1/n); comparing the aggregate score to a predetermined threshold; and approving the concept only if the aggregate score exceeds the predetermined threshold, wherein the geometric mean calculation prevents concepts with high scores in some dimensions but low scores in other dimensions from achieving high aggregate scores, thereby ensuring balanced multi-dimensional performance.

18. The method of claim 17, wherein n equals three and the three dimensions comprise desirability, feasibility, and viability, and wherein the predetermined threshold is 0.75.

19. The method of claim 1, wherein the plurality of specialized processing modules comprises four or more modules, and wherein the dimensions include at least one additional dimension selected from: sustainability assessment, risk assessment, regulatory compliance assessment, or competitive positioning assessment.

20. A non-transitory computer-readable storage medium storing instructions that, when executed by one or more processors, cause the processors to perform the method of claim 1.
